(19) United States
(12) Patent Application Publication
(10) Pub. No.: US 2015/0262210 A1
(43) Pub. Date: Sep. 17, 2015

(54) SYSTEM FOR OFFER DISTRIBUTION

(71) Applicants: Marc-Oliver Klein, Mannheim (DE); Dennis Landscheidt, Mannheim (DE)

(72) Inventors: Marc-Oliver Klein, Mannheim (DE); Dennis Landscheidt, Mannheim (DE)

(21) Appl. No.: 14/215,918

(22) Filed: Mar. 17, 2014

(51) Int. Cl. G06Q 30/02

(52) U.S. Cl. CPC G06Q 30/0214

(57) ABSTRACT

A system and method includes determination of an offer and a first customer, provision of the offer to the first customer, reception of an indication of a redemption of the offer by a second customer, identification of the first customer based on the indication, calculation, in response to identifying the first customer, of a referral value of the first customer based on the indication, and determination of a second offer to provide to the first customer based on the referral value.

### BACKGROUND

1. Field

The embodiments described below relate to technical improvements in the distribution of marketing offers.

2. DESCRIPTION

Marketing offers such as coupons, etc. are traditionally used to increase product awareness and to drive sales. These offers may be distributed via many different channels, including but not limited to mass mailings and media advertisements (i.e., internet, print, television and radio).

Targeted offers may be directed to specific people and/or groups of people. For example, a company may wish to promote a product by providing offers to potential consumers of the product. The company therefore determines (internally and/or with the assistance of a market research company) demographic characteristics (e.g., income, age, location, etc.) of the potential consumers. The company then acquires, from a data provider, the mailing addresses of households which fit the particular demographic characteristics, and mails product coupons or other offers to these households.

Other types of targeted offers exist. In another example, Web pages displayed to a consumer typically include advertisements/offers which are presented based on the consumer's Web browsing and/or search history.

Conventional offer distribution systems fail to efficiently identify consumers to whom the provision of offers may be more cost-efficient than in the case of other consumers.

### BRIEF DESCRIPTION OF THE DRAWINGS

The construction and usage of embodiments will become readily apparent from consideration of the following specification as illustrated in the accompanying drawings, in which like reference numerals designate like parts, and wherein:

FIG. 1 illustrates operation of a system according to some embodiments;

FIG. 2 is a block diagram of a computing device according to some embodiments;

FIG. 3 is a flow diagram of a process according to some embodiments;

FIG. 4 illustrates an offer according to some embodiments;

FIG. 5 illustrates a process according to some embodiments; and

FIG. 6 is a block diagram of a system according to some embodiments.

### DETAILED DESCRIPTION

The following description is provided to enable any person in the art to make and use the described embodiments. Various modifications, however, will remain readily apparent to those in the art.

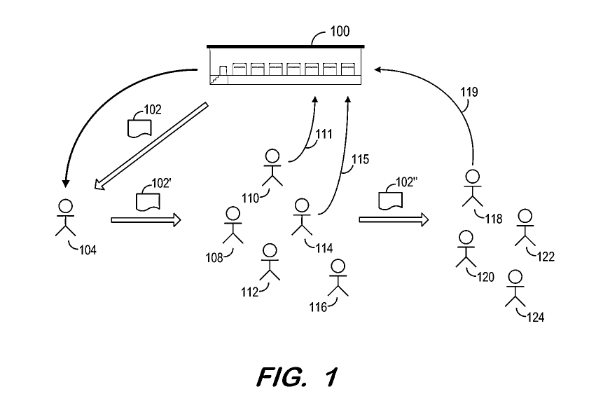

FIG. 1 illustrates operation of a system according to some embodiments. Embodiments are not limited to the illustrated operation and the foregoing description thereof.

As illustrated, company 100 initially provides offer 102 to customer 104. Offer 102 may be embodied in any suitable medium and provided to customer 104 in any suitable manner. For example, offer 102 may be embodied in a paper coupon provided to customer 104 via post, as a newspaper or magazine insert, etc. Offer 102 may comprise electronic data sent to customer 104 via email, or displayed on a Web page accessed by customer 104.

Offer 102 may comprise any type of offer that is or becomes known. For example, offer 102 may comprise a discount (e.g., dollar and/or percentage) off the price of a product or products. Offer 102 may or may not include one or more contingencies (e.g., “10% off purchases over $50”, “buy three, get one free”, etc.).

According to some embodiments, offer 102 identifies customer 104. For example, in addition to including the offer details, offer 102 may include identifying information which is associated with customer 104 within database tables of company 100. The information may be an alphanumeric code, a Quick Response (QR) code, or any other identifying data. Offer 102 may also include information regarding referral credits, which will be described below.

Company 100 may determine offer 102 and customer 104 to whom the offer is sent using any system that is or becomes known. Customer 104 may be identified based on revenue previously received from the customer, demographic information and/or Web search terms. As will be described below, customer 104 may be determined for receipt of the offer based on a referral value which is associated with the customer according to the present embodiments. Although the term “customer” is used herein, customer 104 need not have purchased any goods or services from company 100 prior to receipt of offer 102 according to some embodiments.

According to some embodiments, customer 104 transmits offer 102 to customers 108-116. Offer 102′ includes information describing the terms of offer 102 and information identifying customer 104. Offer 102′ may be embodied in a different form than offer 102 and, except for the previously-mentioned information, may include information different from the information of offer 102.

Offer 102′ may be transmitted to customers 108-116 in any suitable manner, and the type of transmission need not be identical for each of customers 108-116. According to some one example, one or more of customers 108-116 follow customer 104 on Twitter and customer 104 issues a “tweet” from his Twitter account which includes offer 102′. Similarly, one or more of customers 108-116 may be members of customer 104's network on a social networking platform (e.g., Facebook, LinkedIn, MySpace, etc.) and customer 104 may post offer 102′ to his network. Customer 104 may also or alternatively transmit offer 102′ to one or more of customers 108-116 via email.

Arrows 111 and 115 indicate that offer 102′ has been redeemed by customers 110 and 114, respectively, and that company 100 receives indications of the redemptions. Arrows 111 and 115 travel from customers 110 and 114 to company 110 for symbolic purposes; these indications are not typically received directly from customers. For example, offer 102′ may be redeemed in any manner that is or becomes known, such as by inputting a code associated with offer 102′ into an online shopping cart, providing a physical coupon to a merchant at a point-of-sale terminal, etc. The entities which process such transactions then provide the indications to company 100.

Company 100 uses the indications to identify customer 104 and to calculate a referral value for customer 104. For example, the indications may include data which was included in offer 102 and offer 102′ and which directly identifies customer 104 (e.g., a customer number) and/or data (e.g., an offer number) which was included in offer 102 and offer 102′ and which is associated with customer 104 in database tables of company 100.

Calculation of the referral value is based on the number of offer redemptions. For example, referral value=2*number of redemptions. Accordingly, a customer who transmits an offer which is subsequently redeemed by many customers may be associated with a greater referral value than a customer who transmits an offer which is subsequently redeemed by few customers. Calculation of the referral value may be based on any number of additional factors, including but not limited to the offer (e.g., more lucrative-offers exhibit a greater positive effect on the referral value than less-lucrative offers), the redeeming customers (e.g., the positive effect on the referral value increases for subsequent offers redeemed by same customer), and the number of referral “hops” from the originating customer (i.e., customer 104) to the redeeming customer. For example, if customer A sends an offer to customer B, customer B sends the offer to customer C, and customer C sends the offer to customer D, then customer A receives a referral value of 10¹ if the offer is redeemed by customer B, a referral value of 10² if the offer is redeemed by customer C, and a referral value of 10³ if the offer is redeemed by customer D.

In the latter regard, FIG. 1 also illustrates transmission of offer 102″ from customer 114 to customers 118-124. Similar to offer 102′, offer 102″ includes information describing the terms of offer 102 and information identifying customer 104. Offer 102″ may be embodied in a different form than offer 102 and/or offer 102′. Offer 102″ may be transmitted to customers 118-124 in any manner discussed herein, and the type of transmission need not be identical for each of customers 118-124.

As described with respect to arrows 111 and 115, arrow 119 indicates that offer 102″ has been redeemed by customer 118, and that company 100 receives an indication of the redemption. Company 100 uses the indication to identify customer 104 and to update a referral value for customer 104.

According to some embodiments, a referral value associated with customer 104 can also be affected by the distribution of offer 102′. Referring to a previous example, customer 104 issues a tweet including offer 102′. The tweet may be re-tweeted by followers of customer 104, and the referral value of customer 104 may be updated based on the number of re-tweets. This principle may apply for any type of subsequent transmissions of the offer which can be centrally tracked.

The referral value for customer 104 may be used to determine rewards and/or additional offers to provide to customer 104.

In some embodiments, company 100 does not manufacture or sell the product or service which is identified in offer 102. Company 100 may be a marketing/advertising company which is hired by the manufacturer/seller of such a product/service to operate as described herein.

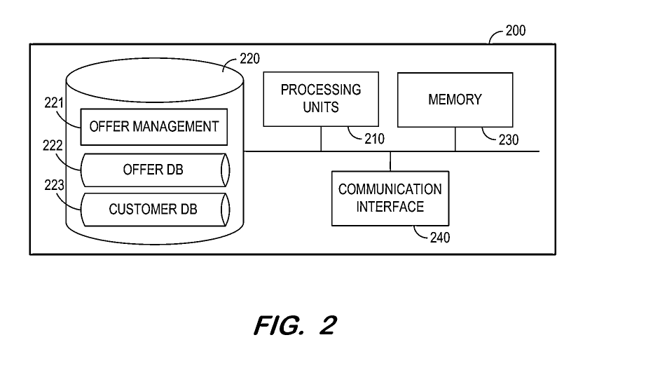

FIG. 2 is a block diagram of general-purpose or dedicated computing device 200 according to some embodiments. Computing device 200 may, for example, be operated by company 100. Computing device 200 includes processing units 210 (e.g., processor cores and/or processing threads) configured to execute processor-executable program code to cause device 200 to operate as described herein, and storage device 220 for storing the program code. Storage device 220 may comprise one or more fixed disks, solid-state random access memory, and/or removable media (e.g., a thumb drive) mounted in a corresponding interface (e.g., a USB port).

Storage device 220 stores program code of offer management program 221. Offer database 222 includes database records describing various offers that may be provided by computing device 200. The database record for an offer may specify, for example, an offer identifier, a product identifier, a discount (e.g., a discounted price, a discount amount or a discount percentage), and referral credits associated with redemption of the offer.

Customer database 223 includes database records specifying, for example, a customer identifier, demographic information, referral credits and a referral value. A customer record may also specify offer identifiers of offers.

The program code of offer management program 221 may be transferred to memory 230 for execution by processing units 210 to determine offers from offer database 222 and associated customers from customer database 223, to calculate referral values and referral credits for customers based on offer redemptions, and to determine offers to provide to customers based on the referral values as described herein. Communication interface 240 may be used to provide offers to customers and to receive indications of offer redemptions.

Computing device 200 may perform functions other than those attributed thereto herein, and may include any elements which are necessary for the operation thereof.

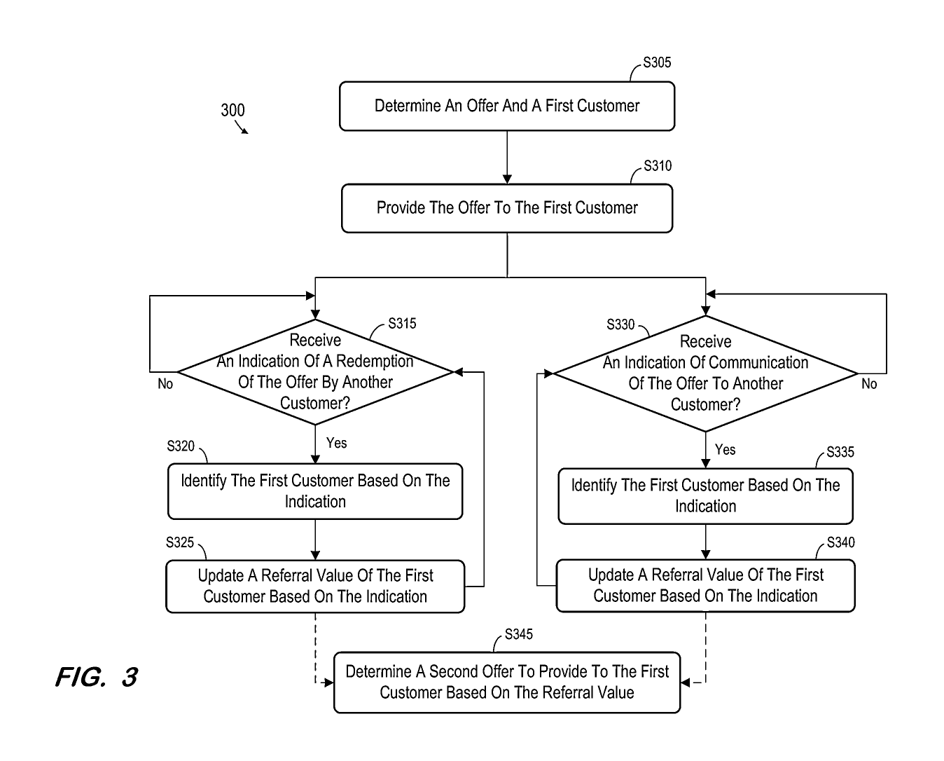

FIG. 3 is a flow diagram of process 300 according to some embodiments. Process 300 and the other processes described herein may be performed using any suitable combination of hardware, software or manual means. Software embodying these processes may be stored by any non-transitory tangible medium, including a fixed disk, a floppy disk, a CD, a DVD, a Flash drive, or a magnetic tape. According to some embodiments, process 300 is performed by a computing device such as computing device 200.

Initially, an offer and a first customer are determined at 5305. As mentioned above, the offer may comprise any type of offer that is or becomes known, and embodiments may employ any currently or hereafter-known system for determining an offer and a customer to whom the offer should be provided. For example, the customer may be identified based on demographic information and/or Web search terms.

The offer is provided to the first customer at S310. The offer may be embodied in any suitable medium and provided to the first customer in any suitable manner. As described with respect to FIG. 1, the offer may be embodied in a paper coupon provided to the first customer via post or as electronic data sent to the first customer via email or a Web page.

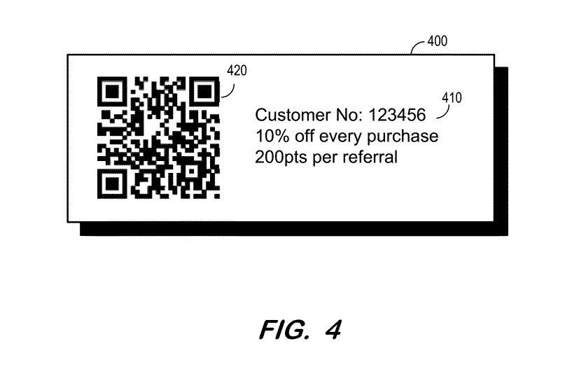

According to some embodiments, the offer identifies the first customer. FIG. 4 is a view of offer 400 according to some embodiments. Offer 400 may comprise paper, or pixels displayed on a display screen of a desktop computer, a tablet computer, a smartphone, etc. Offer 400 includes text 410 identifying the first customer (“Customer No: 123456”), and details of the offer (“10% off every purchase”). Text 410 also specifies referral credits (“200 pts per referral”) which accrue to the first customer per referral.

Offer 400 also includes QR code 420, which may encode the information of text 410 and/or other information as is known in the art. QR code 420 may include additional information according to some embodiments. Offer 400 may include any other suitable information, and need not include text and a QR code according to some embodiments.

Flow branches from S310 to S315 and S330. At S315, flow pauses until reception of an indication of a redemption of the offer by another customer. At S330, flow pauses until reception of an indication of communication of the offer to another customer.

Turning to S315, an indication of redemption by another customer may be received from a retailer (e.g., online, brick-and-mortar), a payment processor (e.g., credit card company, bank) or from the other customer (e.g., via a Web interface). In response, the first customer is identified based on the indication at S320.

The first customer is identified at S320 based on data which was included in the offer and therefore passed along with the offer to the redeeming customer. For example, if offer 400 is redeemed, the indication of the redemption specifies Customer No: 123456 and/or QR code 420, which also identifies Customer No: 123456.

A referral value associated with the first customer is updated at S325 based on the indication. In some embodiments, the referral value is updated based on the number of offer redemptions associated with the first customer. The referral value may be updated based on any number of additional factors, including but not limited to the offer (e.g., more lucrative-offers exhibit a greater positive effect on the referral value than less-lucrative offers), the redeeming customers (e.g., the positive effect on the referral value increases for subsequent offers redeemed by same customer), and the number of referral “hops” from the first customer to the redeeming customer.

According to some embodiments, the first customer also accrues referral credits as described in text 410. Referral credits may comprise any type of customer benefit that is or becomes known, including but not limited to loyalty points, cash credits, and/or special privileges. As described with respect to referral values, calculation of referral credits may be based on the specifics of the other customer's redemption (e.g., a more-profitable redemption results in more referral credits than a less-profitable redemption), on the number of “hops” between the first customer and the redeeming customer, and/or on any other considerations.

Flow returns from S325 to S315 to await receipt of an indication of a next redemption. Steps S330 through S340 may execute in parallel with S315 through S325 according to some embodiments. In this regard, many instantiations of process 300 may be performed in parallel, each of which is associated with a unique combination of offer and first customer.

Flow proceeds from S330 to S335 upon reception of an indication that the offer has been communicated to another customer. The offer may be communicated to the other customer in any suitable manner, and detection thereof may also proceed in any suitable manner. According to some examples, the first customer issues a “tweet” from his Twitter account which includes offer 400. This action may be considered a single communication for purposes of process 300, or the first customer may be credited for one communication per Twitter follower. In another example, “retweets” of the initial tweet are detected using an Application Programming Interface provided by Twitter, and each retweet is considered one communication of the offer.

The first customer is identified based on the indication at S335, using techniques described above with respect to S320. The referral value associated with the first customer is then updated at S340 based on the indication. In some embodiments, the referral value is updated at S340 based on the number of offer communications initiated by the first customer. The referral value may be updated based on any number of additional factors, including but not limited to the whether the offer was subsequently re-communicated (e.g., retweets). According to some embodiments, the first customer also accrues referral credits as described above based on communication of the offer. the first customer and the redeeming customer, and/or on any other considerations.

Flow returns from S340 to S330 to await receipt of an indication of a next communication. As illustrated by the dotted arrow, S345 may execute in parallel with the other steps of process 300. Specifically, during execution of the other steps of process 300, a second offer may be determined at S345. The second offer is to be provided to the first customer based on the referral value currently associated with the customer. For example, it may be determined at S345 to only send a certain offer to those customers associated with a referral value above a threshold.

Advantageously, some embodiments provide a technical solution to the technical problem of efficiently identifying customers who are more-desirable recipients of offers than other customers, from an economic and/or marketing perspective.

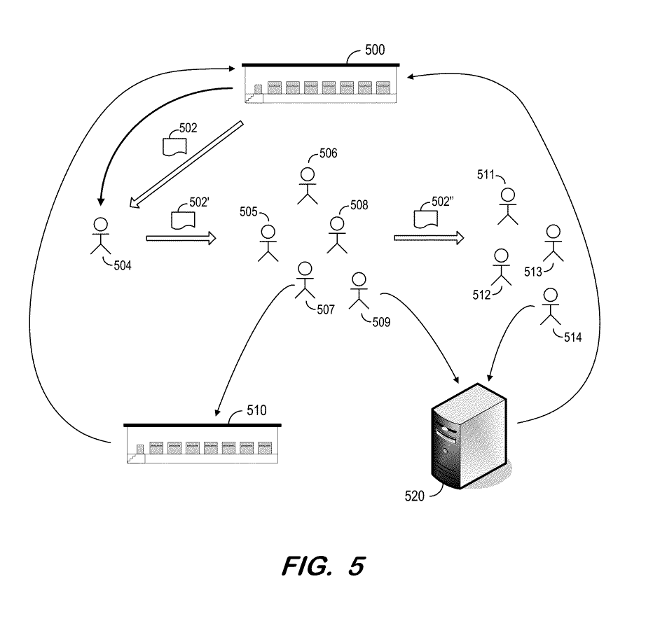

Embodiments are not limited to the specifics of the foregoing examples. FIG. 5 illustrates operation of a system according to some embodiments. As shown, offer provider 500 initially provides offer 502 to customer 504. Offer 502 identifies customer 504, and customer 504 subsequently transmits offer 502′ to customers 505-509, via one or several communication modes. Offer 502′ includes information describing the terms of offer 502 and information identifying customer 504.

Customer 507 redeems offer 502′ at brick-and-mortar retail store 510. Store 510 and offer provider 500 may be co-owned or separate entities. Redemption of the offer may consist of scanning of a coupon or QR code at store 510. Store 510 then transmits an indication of the redemption to offer provider 500.

Customer 509 redeems offer 502′ at online store 520. Redemption of the offer may consist of providing a coupon code or a QR code to online store 520. Store 520 also transmits an indication of the redemption to offer provider 500.

FIG. 5 also illustrates transmission of offer 502″ from customer 508 to customers 511-514. Offer 502″ may be transmitted to customers 511-514 in any manner discussed herein, and the type of transmission need not be identical for each of customers 511-514. Offer 502″ includes information describing the terms of offer 502 and information identifying customer 504.

Customer 514 redeems offer 502″ at online store 520. The redemption may include providing a coupon code or a QR code to online store 520. Again, store 520 transmits an indication of the redemption to offer provider 500.

As described above, offer provider 500 may update a referral value of customer 504 based on the received redemption indications, and may determine a second offer to provide to customer 504 based on the referral value.

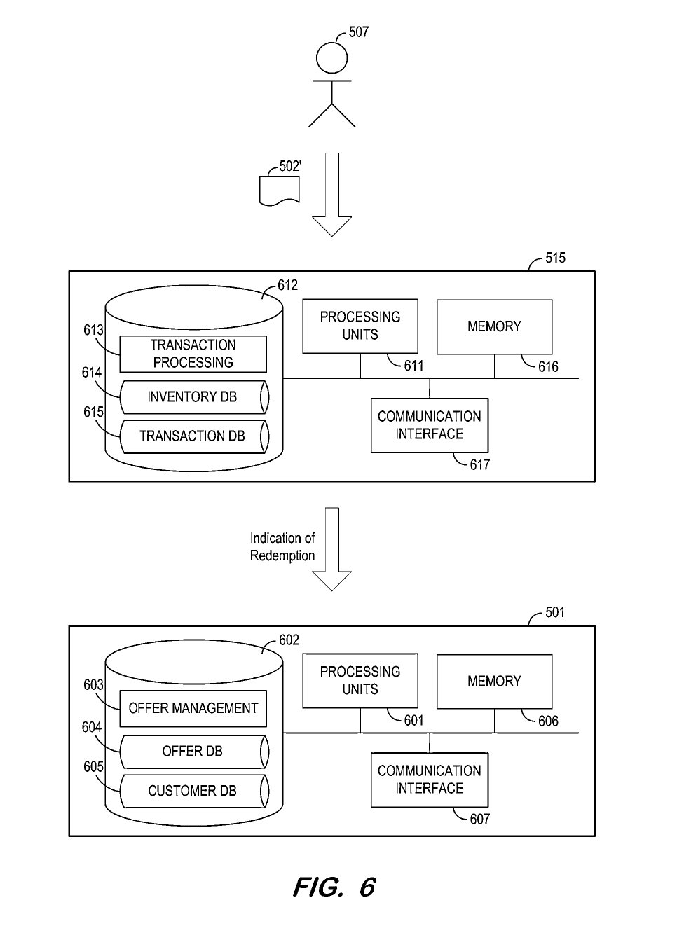

FIG. 6 is a block diagram of computing devices 501 and 515 operated by offer provider 500 and store 510, respectively, according to some embodiments. FIG. 6 illustrates an example of redemption of offer 502′ by customer 507 as described above. Each of computing devices 501 and 515 includes processing units (e.g., processor cores and/or processing threads) configured to execute processor-executable program code, and storage devices for storing the program code.

Storage device 612 of device 515 stores program code of transaction processing program 613. Transaction processing program may 613 may be executed to receive item data and payment data, and to update inventory database 614 and transaction database 615 accordingly. Transaction processing program may 613 may also be executed to interface with payment processing systems (not shown).

Transaction processing program 613 may further be executed to process a redemption of offer 502′ (e.g., apply a discount) and determine an identifier corresponding to customer 507. The identifier may be a code or other data, such that the code does not reveal the identity of customer 507 in and of itself. Transaction processing program 613 is then executed to transmit an indication of the redemption to computing device 501 of offer provider 500.

The program code of offer management program 603 is executed calculate referral values and referral credits for customer 507 based on the offer redemption, and to determine a second offer to provide to customer 507 based on the referral values as described herein. Communication interface 607 may be used to provide offers to customers and to receive the indications of offer redemptions.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A system comprising:
a computing device comprising:
a communication interface;
a memory storing processor-executable program code; and
a processor to execute the processor-executable program code in order to cause the computing device to:
determine an offer and a first customer;
provide the offer to the first customer via the communication interface;
receive an indication of a redemption of the offer by a second customer via the communication interface;
identify the first customer based on the indication and on stored data associating the first customer with the offer;
in response to identification of the first customer, calculate a referral value of the first customer based on the indication; and
determine a second offer to provide to the first customer based on the referral value.

2. A system according to claim 1, the processor to execute the processor-executable program code in order to further cause the computing device to:
provide, in response to identifying the first customer, referral credits to the first customer.

3. A system according to claim 1, the processor to execute the processor-executable program code in order to further cause the computing device to:
receive a second indication of communication of the offer;
identify the first customer based on the second indication and on the stored data associating the first customer with the offer;
update, in response to identifying the first customer based on the second indication, the referral value of the first customer; and
determine a third offer to provide to the first customer based on the updated referral value.

4. A system according to claim 3, wherein reception of the second indication of communication of the offer comprises reception of data from a social network indicating communication of the offer from the first customer to one or more other members of the social network.

5. A system according to claim 3, the processor to execute the processor-executable program code in order to further cause the computing device to:
provide, in response to identifying the first customer based on the second indication, referral credits to the first customer.

6. A system according to claim 1, wherein the offer identifies the first customer.

7. A non-transitory computer-readable medium storing program code, the program code executable by a processor of a computing system to cause the computing system to:
determine an offer and a first customer;
provide the offer to the first customer via the communication interface;
receive an indication of a redemption of the offer by a second customer via the communication interface;
identify the first customer based on the indication and on stored data associating the first customer with the offer;
in response to identification of the first customer, calculate a referral value of the first customer based on the indication; and
determine a second offer to provide to the first customer based on the referral value.

8. A medium according to claim 7, the program code executable by the processor of the computing system to further cause the computing system to:
provide, in response to identifying the first customer, referral credits to the first customer.

9. A medium according to claim 7, the program code executable by the processor of the computing system to further cause the computing system to:
receive a second indication of communication of the offer;
identify the first customer based on the second indication and on the stored data associating the first customer with the offer;
update, in response to identifying the first customer based on the second indication, the referral value of the first customer; and
determine a third offer to provide to the first customer based on the updated referral value.

10. A medium according to claim 9, wherein reception of the second indication of communication of the offer comprises reception of data from a social network indicating communication of the offer from the first customer to one or more other members of the social network.

11. A medium according to claim 9, the program code executable by the processor of the computing system to further cause the computing system to:
provide, in response to identifying the first customer based on the second indication, referral credits to the first customer.

12. A medium according to claim 7, wherein the offer identifies the first customer.

13. A computer-implemented method comprising:
determining an offer and a first customer;
providing the offer to the first customer;
receiving an indication of a redemption of the offer by a second customer;
identifying the first customer based on the indication;
in response to identifying the first customer, calculating a referral value of the first customer based on the indication; and
determining a second offer to provide to the first customer based on the referral value.

14. A computer-implemented method according to claim 13, further comprising:
in response to identifying the first customer, providing referral credits to the first customer.

15. A computer-implemented method according to claim 13, further comprising:
receiving a second indication of communication of the offer;
identifying the first customer based on the second indication;
in response to identifying the first customer based on the second indication, updating the referral value of the first customer; and
determining a third offer to provide to the first customer based on the updated referral value.

16. A computer-implemented method according to claim 15, wherein receiving the second indication of communication of the offer comprises receiving data from a social network indicating communication of the offer from the first customer to one or more other members of the social network.

17. A computer-implemented method according to claim 15, further comprising:
in response to identifying the first customer based on the second indication, providing referral credits to the first customer.

18. A computer-implemented method according to claim 13, wherein the offer identifies the first customer.
